(19) United States
(12) Patent Application Publication
(10) Pub. No.: US 2008/0164721 A1
(43) Pub. Date: Jul. 10, 2008

(54) Expansible cap

(76) Inventor: Thomas Daniel Semotuk, Climax Springs, MO (US)

Correspondence Address: THOMAS D. SEMOTUK, USACE GRS, APO, AE, 09331, omitted

(21) Appl. No.: 11/651,218

(22) Filed: Jan. 10, 2007

(51) Int. Cl. B60P 3/345

(52) U.S. Cl. 296/165

(57) ABSTRACT

An expansible cap (01) comprised of a cap (10) and a base assembly (20) that rests on or off a means of transport (02). Base assembly (20) is comprised of an enclosure assembly (30), a wall assembly (40), a frame (50), and an elevating mechanism (60). When closed for storage and transport, cap (10) generally conforms to the contours of the means of transport (02) and encloses base assembly (20). Enclosure assembly (30) is folded. The inside of expansible cap (01) is available for cargo or as a camping shelter.

Cap (10)) is attached to elevating mechanism (60). Cap (10) is elevated or lowered by means of elevating mechanism (60). When cap (10) is elevated, enclosure assembly (30) encloses the space between wall assembly (40) and cap (10). The inside of expansible cap (01) is available as a much larger shelter for camping.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A SEQUENCE LISTING, A TABLE, OR A COMPUTER PROGRAM LISTING COMPACT DISC APPENDIX

Not Applicable.

### BACKGROUND OF THE INVENTION

The present invention relates generally to an expansible cap that is expansible from one configuration usable for camping to another configuration usable for camping and can be installed on a means of transport such as a pickup truck or off the means of transport.

Caps and campers have been in use for years. A conventional cap is typically fabricated as a rigid unit to rest on the means of transportation such as a pickup truck and be semi permanently attached to it. The caps have an aerodynamic shape that generally conforms to the contours of the means of transport. The cap provides a weather resistant enclosure that can be used as a camping shelter or for carrying cargo. The main problems with conventional caps are that they do not provide adequate headroom to stand upright and they cannot be expanded to provide additional room for habitation. Additionally, they cannot be used off the means of transport.

Typically, a conventional camper has a floor, front and rear walls, sidewalls and a roof forming a rigid rectangular structure. The main problem is that conventional campers are wider and higher than the means of transport that they rest upon. Consequently they obscure the rear view of the driver when in motion contributing to safety concerns; they are not aerodynamic and increase wind resistance and increase fuel consumption; they are heavy; they raise the center of gravity and provide a large sail area in high winds that serves to destabilize the means of transport; they will not fit within a typical residential garage; and they may be subject to road and bridge restrictions. They are not intended to remain on the means of transport for routine day to day operations and typically must be removed from the means of transport and stored when not being used for camping.

Caps are often used for shelter when camping. Bedding and other furnishings are placed on the floor of the means of transport. The cap and means of transport together provide a weather resistant enclosure. Various methods have been used to improve caps by providing some means of expanding them to make them more spacious for habitation as campers. Examples of patents that are illustrative of this prior art follow.

U.S. Pat. No. 6,712,421 to Wilson attempts to increase the interior space by means of a series of hinges and shock strut assemblies to raise the cap to a tilted position and fabric inserts to enclose the space between the cap and the means of transport. The main drawback of this is that it is awkward to use and provides limited interior space. The assembly cannot be used as a freestanding habitation.

U.S. Pat. No. 6,439,647 to Baldwin attempts to increase the interior space by using a pair of nested caps that fold outward to increase the size of the enclosure. This is also awkward to use and requires the nested caps to be fastened to the means of transport. The assembly cannot be used as a freestanding habitation.

Various methods have been tried to improve campers by installing some form of roof lowering mechanism to reduce the overall height of the assembly when closed. These efforts have not addressed the other disadvantages listed. Examples of patents that are illustrative of this prior art follow.

U.S. Pat. No. 6,679,542 to Semotuk overcomes many of the disadvantages of the previous art but has the disadvantage of numerous external seams when the camper is closed that allow water to penetrate the interior of the camper. Additionally the front and rear upper enclosures are awkward to operate.

U.S. Pat. No. 6,283,536 to Muzyka in which the inventor uses a system of multiple folding side wings that fold in upon themselves. This device requires numerous external supports and jacks to support it. It must extend horizontally beyond the sides of the vehicle in order for the vertical jacks to reach the ground. This obstructs rear vision and reduces clearance between the vehicle and other vehicles or obstructions thereby creating a safety hazard. It also increases the difficulty of putting the vehicle in a residential garage.

U.S. Pat. No. 6,170,502 to Pullen relies on a system of numerous chains, sprockets, cranks, and pulleys that require careful alignment, maintenance and lubrication and are prone to mechanical failure to elevate the roof. It requires removing and installing side frames that contain numerous receiving tubes that must be aligned. It does not eliminate the high profile that contributes to increased wind resistance and fuel consumption; the high profile also contributes to dangerous instability conditions created by high side winds while in motion. The device does not have an aerodynamic shape and does not conform to the aerodynamic contours of the vehicle.

### BRIEF SUMMARY OF THE INVENTION

An expansible cap (01) for a means of transport (02) such as a pickup truck. A cap (10) is attached to a base assembly (20) comprised of an enclosure assembly (30), a wall assembly (40), a frame (50), and an elevating mechanism (60). The cap (10) is formed to conform to the contours of the means of transport (02). Said base assembly (20) is formed to fit within the contours of the means of transport (02). Said enclosure assembly (30) is comprised of a front enclosure (31), a rear enclosure (32), and a pair of side enclosures (33). Said wall assembly (40) is comprised of a front wall (41), a pair of rear walls (42), a pair of side walls (43), a floor (44), and a door (45) rotatably connected to one of said rear walls (42). Said frame (50) is comprised of a pair of side members (51), a plurality of transverse members (52), and a plurality of uprights (53). Said wall assembly (40) is fastened to said frame (50). Said elevating mechanism (60) is comprised of a plurality of telescopic inserts (61), a plurality of pulleys (62), a plurality of cables (63), and a winch (64). Front enclosure (31) is fastened to the top edge of front wall (41) and the underside of cap (10). Rear enclosure (32) is fastened to the top edges of rear walls (42) and the underside of cap (10). Side enclosures (33) are fastened to the upper edges of side walls (43) and the underside of cap (10). When closed for storage and transport, front enclosure (31), rear enclosure (32), and side enclosures (33) are folded inward. Cap (10) rests on base assembly (20) and the interior of expansible cap (01) is available for carrying cargo or as a camping shelter. When expanded, cap (10) is raised by means of elevating mechanism (60). Winch (64) is attached to cables (63) that ride over and around pulleys (62) and are fastened to the lower ends of telescopic inserts (61). Telescopic inserts (61) are slidably inserted into uprights (53) and fastened to the underside of cap (10). Winch (64) is turned reeling in cables (63) and elevating telescopic inserts (61) whereby cap (10) is elevated carrying the upper edges of the enclosure assembly (30) with it. The front outer side edges of side enclosures (33) are removably fastened to the outer side edges of front enclosure (31) and front wall (41). The rear outer side edges of side enclosures (33) are removably fastened to the outer side edges of rear enclosure (32), and rear walls (42). Together, front enclosure (31), rear enclosure (32), and side enclosures (33) enclose the area between cap (10) and wall assembly (40), whereby a large weather resistant enclosure for habitation is provided. Door (45) provides access to the interior.

The objective of the present expansible cap is to provide a shelter for people for the purpose of camping when closed that conforms to the contours of the means of transportation and can be conveniently expanded into a much larger shelter for use on or off the means of transport.

Other objectives of the present invention will become apparent to the reader from consideration of the drawings and ensuing description. It is intended that these objects and advantages are within the scope of the present invention.

To the accomplishment of the above and related objects this invention may be embodied in the form illustrated in the accompanying drawings. However, the drawings are illustrative only, and changes may be made in the specific construction illustrated and described within the scope of the appended claims.

### BRIEF DESCRIPTION OF THE SEVERAL VIEWS OF THE DRAWINGS

FIG. 1 shows a perspective view of the expansible cap mounted on a means of transport in the closed configuration for transport and storage.

FIG. 2 shows a perspective view of the expansible cap in the expanded configuration for habitation mounted on a means of transport.

FIG. 3 shows a perspective view of the expansible cap in the expanded configuration for habitation off the means of transport.

FIG. 3A shows a perspective view of the expansible cap depicted in FIG. 3 with cap removed to show components of enclosure assembly and wall assembly.

FIG. 3B shows a perspective view of the expansible cap depicted in FIG. 3A with enclosure assembly and wall assembly removed to show components of the frame and elevating mechanism.

FIG. 3C shows a perspective view of the arrangement of the elevating mechanism.

### REFERENCE NUMERALS IN THE DRAWINGS

01 expansible cap 44 floor
02 means of transport 45 door
10 cap 50 frame
20 base assembly 51 side members
30 enclosure assembly 52 transverse members
31 front enclosure 53 uprights
32 rear enclosure 60 elevating mechanism
33 side enclosures 61 telescopic inserts
40 wall assembly 62 pulleys
41 front wall 63 cables
42 rear walls 64 winch
43 side walls

### DETAILED DESCRIPTION OF THE INVENTION

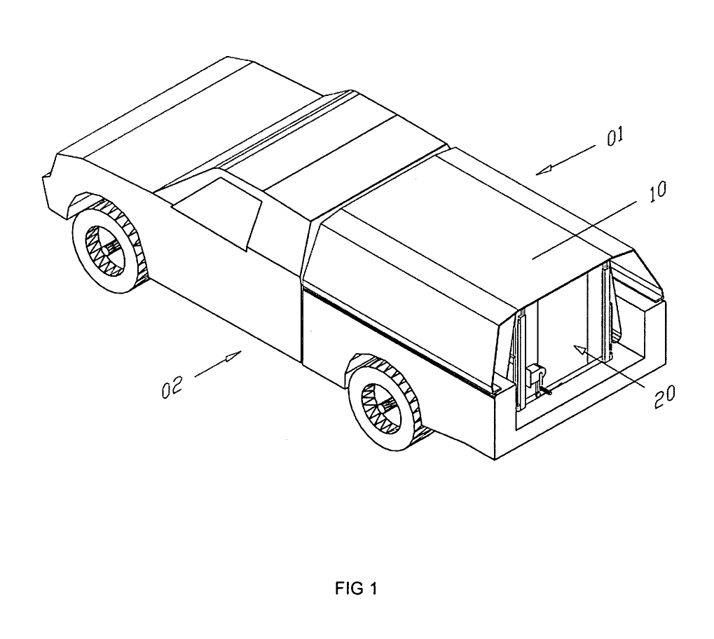

### Description—FIG. 1:

Expansible cap 01 is comprised of a cap 10 and a base assembly 20. Base assembly 20 is positioned on a means of transport 02. Cap 10 is attached to said base assembly 20. Expansible cap 01 is closed for transport or storage. The interior of expansible cap 01 is available for cargo or as a camping shelter.

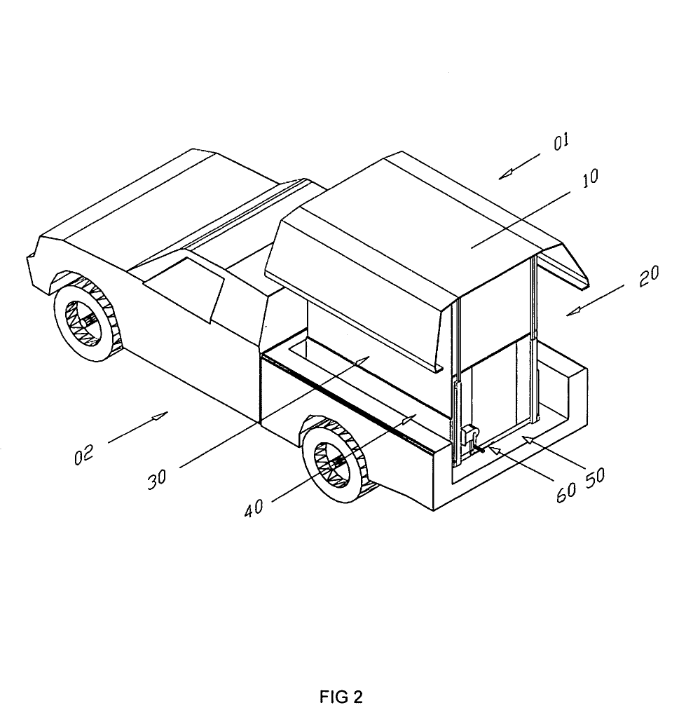

### Description—FIG. 2:

Expansible cap 01 is comprised of a cap 10 and a base assembly 20. Base assembly 20 is positioned on a means of transport 02. Cap 10 is attached to said base assembly 20. Base assembly 20 is comprised of an enclosure assembly 30, a wall assembly 40, a frame 50, and an elevating mechanism 60. The lower edges of enclosure assembly 30 are fastened to the upper edges of wall assembly 40. The upper edges of enclosure assembly 30 are fastened to the underside of cap 10. Wall assembly 40 is fastened to frame 50. Elevating mechanism 60 is fastened to frame 50 and the underside of cap 10. Expansible cap 01 is fully expanded and available for habitation.

### Operation—FIG. 2:

Cap 10 is raised by elevating mechanism 60 carrying the upper edges of enclosure assembly 30 with it. The outer side edges of enclosure assembly 30 are removably fastened at the corners. Expansible cap 01 is ready for habitation.

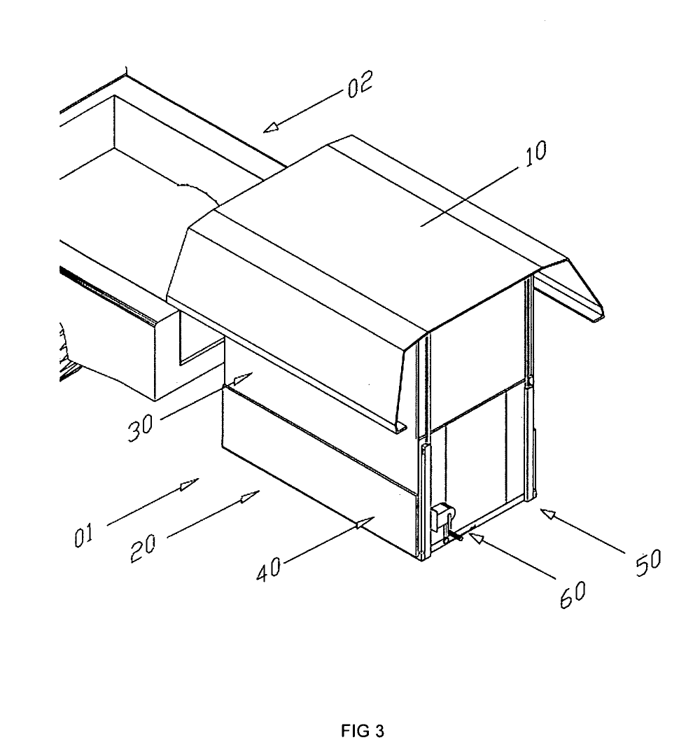

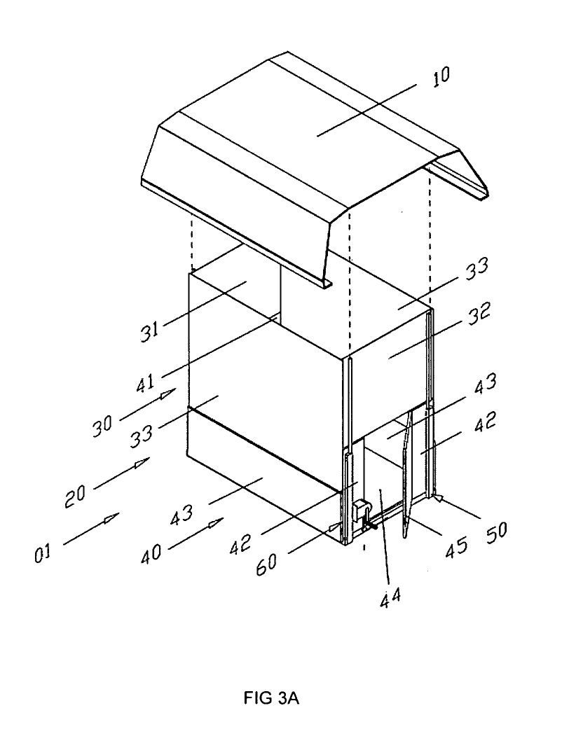

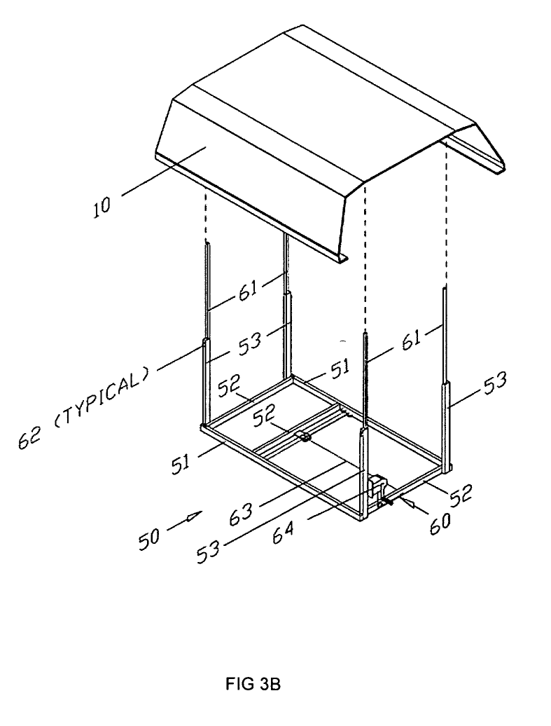

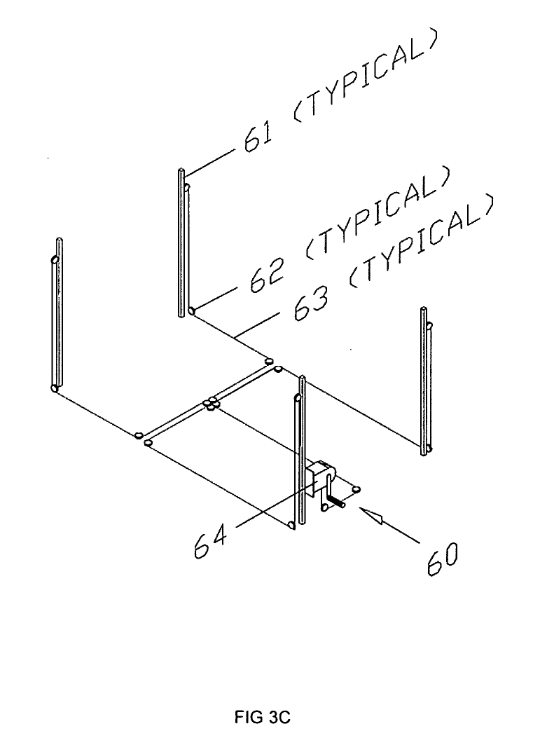

### Description—FIG. 3:

Expansible cap 01 is comprised of a cap 10 and a base assembly 20. Base assembly 20 is positioned off a means of transport 02. Cap 10 is attached to said base assembly 20. Base assembly 20 is comprised of an enclosure assembly 30, a wall assembly 40, a frame 50, and an elevating mechanism 60. The lower edges of enclosure assembly 30 are fastened to the upper edges of wall assembly 40. The upper edges of enclosure assembly 30 are fastened to the underside of cap 10. Wall assembly 40 is fastened to frame 50. Elevating mechanism 60 is fastened to frame 50 and the underside of cap 10. Expansible cap 01 is fully expanded and available for habitation.

### Operation—FIG. 3:

Cap 10 is elevated by elevating mechanism 60 carrying the upper edges of enclosure assembly 30 with it. The outer side edges of enclosure assembly 30 are removably fastened at the outer side corners. Expansible cap 01 is ready for habitation.

### Description—FIG. 3A:

An expansible cap 01 is comprised of a cap 10, and a base assembly 20. Said base assembly is comprised of an enclosure assembly 30, a wall assembly 40, a frame 50, and an elevating mechanism 60. Cap 10 is removed to show details of enclosure assembly 30 and wall assembly 40. Said enclosure assembly 30 is comprised of a front enclosure 31, a rear enclosure 32, and a pair of side enclosures 33. Said wall assembly 40 is comprised of a front wall 41, a pair of rear walls 42, a pair of side walls 43, a floor 44, and a door 45. Said door 45 is pivotally fastened to one rear wall 42. Said wall assembly 40 is fastened to frame 50. Elevating mechanism 60 is fastened to frame 50 and the underside of cap 10. The lower edge of front enclosure 31 is fastened to the upper edge of front wall 41. The upper edge of front enclosure 31 is fastened to the underside of cap 10. The lower edge of rear enclosure 32 is fastened to the upper edges of rear walls 42. The upper edge of rear enclosure 32 is fastened to the underside of cap 10. The lower edges of side enclosures 33 are fastened to the upper edges of side walls 43. The upper edges of side enclosures 33 are fastened to the underside of cap 10. The outer side edges of side enclosures 33 are removably fastened to the outer side edges of front enclosure 31, front wall 41, rear enclosure 32, and rear walls 42.

### Operation—FIG. 3A:

Elevating mechanism 60 is operated to elevate cap 10. Cap 10 carries the upper edges of enclosure assembly 30 with it. The outer side edges of side enclosures 33 are removably fastened to the outer side edges of front enclosure 31, front wall 41, rear enclosure 32, and rear walls 42. Expansible cap 01 is ready for habitation.

### Description—FIG. 3B:

A frame 50 is comprised of a pair of side members 51, a plurality of transverse members 52, and a plurality of uprights 53. Said transverse members 52 are fastened to side members 51. The lower ends of uprights 53 are fastened to transverse members 52. An elevating mechanism 60 is comprised of a plurality of telescopic inserts 61, a plurality of pulleys 62, a plurality of cables 63, and a winch 64. Telescopic inserts 61 are slidably inserted into uprights 53. Pulleys 62 are rotatably attached at the upper ends of uprights 53, the front ends of side members 51, the rear ends of side members 51, the middle of side members 51, and at points on transverse members 52, as shown. Winch 64 is fastened to one upright 53. Cables 63 are fastened to the lower ends of telescopic inserts 61. Said cables 63 run over and around pulleys 62 and are fastened to winch 64. The upper ends of telescopic inserts 61 are fastened to the underside of cap 10.

### Operation—FIG. 3B:

Winch 64 is turned whereby cables 63 are reeled in elevating telescopic inserts 61 and attached cap 10.

### Description—FIG. 3C:

FIG. 3C shows the arrangement of an elevating mechanism 60 shown in FIG. 3B comprised of a plurality of telescopic inserts 61, a plurality of pulleys 62, a plurality of cables 63, and a winch 64.

I claim:

1. An expansible cap that is expansible from one configuration usable for camping to another configuration usable for camping comprising:
a base assembly positionable on or off a means of transport;
a cap attached to said base assembly by a means for elevating and lowering.
a means for enclosing a space between the cap and base assembly when expanded.
